(19) United States
(12) Patent Application Publication
(10) Pub. No.: US 2024/0377812 A1
(43) Pub. Date: Nov. 14, 2024

(54) SENSOR GRID SYSTEM MANAGEMENT

(71) Applicant: Telefonaktiebolaget LM Ericsson (publ), Stockholm (SE)

(72) Inventors: Péter HÁGA, Budapest (HU); Aitor HERNANDEZ HERRANZ, Stockholm (SE); Zsófia KALLUS, Budapest (HU); Máté SZEBENYEI, Budapest (HU)

(21) Appl. No.: 18/692,020

(22) PCT Filed: Sep. 15, 2021
(86) PCT No.: PCT/EP2021/075371

§ 371 Date: Mar. 14, 2024

(51) Int. Cl. G05B 19/4155

(52) U.S. Cl. CPC G05B 19/4155; G05B 2219/40577

(57) ABSTRACT

Embodiments disclosed herein relate to methods and apparatus for managing a sensor grid system including configuring and using sensor grids for various tasks. In one embodiment there is provided a method of configuring a sensor grid system having a plurality of sensors arranged to collect data from a working space. The method includes applying an output from the sensors to a task model for performing a task associated with the working space. A task accuracy parameter is corresponding to the accuracy with which the task model performs the task is determine. In response to the task accuracy parameter being below a task accuracy parameter threshold, the resolution of the output from the sensors is increased, and the complexity of the task model is increased.

### TECHNICAL FIELD

Embodiments disclosed herein relate to methods and apparatus for managing a sensor grid system including configuring and using sensor grids and a task model for various tasks.

### BACKGROUND

Sensor grids having a plurality of sensors for collecting data can be used to help monitor and manage various systems and workspaces. Examples include monitoring human interactions with automated devices such as robots or autonomic guided vehicles (AGV) in smart factories or warehouses. The data may be used to prevent human machine collisions, improve robot movements to facilitate interaction with humans, or secure an area against unexpected incursion.

Machine learning (ML) may be coupled with the data collected for from the sensors for training and to perform various tasks or functions. The sensors may be Internet of Things (IoT) devices that communicate wirelessly with other sensors and/or controllers. A consideration in deploying and using such sensor grids is the energy they consume and the need for improved energy efficiency.

Current approaches to this challenge include compressing or decreasing the data transmitted by the sensors, using smaller ML models and/or limiting training of the ML models to a particular accuracy level. For example, Dube et al: “Stream sampling: A Novel Approach of IoT Stream Sampling and Model Update on the IoT Edge Device for Class Incremental Learning in an Edge-Cloud System” uses a sample selection method that discards certain training images on the IoT edge device to reduce transmission cost.

Azar et al: “Data compression on edge device: An energy efficient IoT data compression approach for edge machine learning” applies a fast error-bounded lossy compressor on the collected data prior to transmission and rebuild the transmitted data on an edge node, then process this using supervised machine learning techniques.

Rashtian et al: “RL for optimal model structure: Using Deep Reinforcement Learning to Improve Sensor Selection in the Internet of Things” considers whether data packets (either regarding criticality or timeliness) of two or more sensors are correlated, or there exists temporal dependency among sensors, in order to help with sensor selection within a sensor grid.

However, further improvements in energy efficiency is desirable in relation to the training, configuration and operation of sensor grids in order to reduce energy consumption by smart factories and warehouses and the like.

### SUMMARY

In one aspect, there is provided a method of configuring a sensor grid system having a plurality of sensors arranged to collect data from a working space. The method comprises applying an output from the sensors to a task model for performing a task associated with the working space and determining a task accuracy parameter corresponding to the accuracy with which the task model performs the task. In response to the task accuracy parameter (365) being below a task accuracy parameter threshold, increasing the resolution of the output from the sensors and increasing the complexity of the task model.

According to certain embodiments described here, the task may comprise detecting predetermined objects, controlling automated devices, quality assurance of automated devices, identifying security threats, and many other potential tasks. The resolution of the output from the sensors may be increased by tuning one or more of the following parameters of the sensors: pixel resolution; sampling frequency; quantization; bandwidth; filtering; the number of sensors. The sensors may be thermometers; thermal imaging sensors; cameras or any other sensor type.

According to certain embodiments described herein, the task comprises detecting predetermined objects such as persons and an output of the sensor grid is used to control automated devices such as autonomic guided vehicles within the working space.

According to certain embodiments described here, the task model may be a neural network (NN) such as a trained NN or a pre-trained NN which is trained using the using the output from the sensors. The NN may be partially or fully trained using transfer learning from another neural network trained in a different working space or on a different task. Increasing the complexity of the task model may comprise using another neural network having a change in one or more of the following architectural parameters: input resolution; layer depth; layer width; layer composition and/or order.

In another aspect, there is provided an apparatus for configuring a sensor grid system having a plurality of sensors arranged to collect data from a working space. The apparatus comprises a processor and memory containing instructions which are executable by the processor whereby the apparatus is operative to apply an output from the sensors to a task model for performing a task associated with the working space and to determine a task accuracy parameter corresponding to the accuracy with which the task model performs the task. In response to the task accuracy parameter being below a task accuracy parameter threshold the apparatus increases the resolution of the output from the sensors and increases the complexity of the task model.

Certain embodiments described herein provide a system comprising the sensor grid having a plurality of sensors arranged to collect data from the working space and the task model. The sensors and the task model are configured by the apparatus. The apparatus may then also use the configured sensors and task model to perform the task.

According to certain embodiments described herein there is provided a computer program comprising instructions which, when executed on a processor, causes the processor to carry out the methods described herein. The computer program may be stored on a non transitory computer readable media.

### BRIEF DESCRIPTION OF DRAWINGS

For a better understanding of the embodiments of the present disclosure, and to show how it may be put into effect, reference will now be made, by way of example only, to the accompanying drawings, in which:

FIG. 1 is a schematic diagram illustrating a system comprising a sensor grid according to an embodiment;

FIG. 2 is a flow chart of a method of configuring and using a sensor grid system according to an embodiment;

FIG. 3 illustrates training and selection of task models for a system using a sensor grid according to an embodiment;

FIG. 4 is a flow chart of a method of configuring and using a sensor grid system according to another embodiment; and

FIG. 5 illustrates an apparatus according to an embodiment for configuring a sensor grid system.

### DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Embodiments described herein relate to methods and apparatus for configuring and using a system employing a sensor grid whilst minimizing energy usage. The sensor grid comprises a plurality of sensors arranged to collect data from a working space such as a Smart factory floor or the outside grounds of a university campus. The system may be configured for many different tasks, such as avoiding collisions between AGV and humans in a smart warehouse, improving robot human interactions in a smart factory, improving security in an office building and so on. The sensors are tunable and various resolution parameters may be configurable such as pixel resolution, sampling frequency, quantization bandwidth, filtering and number or density of the sensors. The output from the sensors is applied to a task model in order to perform the desired task in relation to the working space.

In some embodiments the resolution of the sensors and the complexity of the task model is increased to enable a predetermined task accuracy. By starting with a low sensor resolution and/or task model complexity, then increasing this to attain a predetermined task accuracy, an energy efficient configuration for the system is determined. This configuration may then be deployed to perform the desired task, whilst at the same time minimizing the energy requirements of the system.

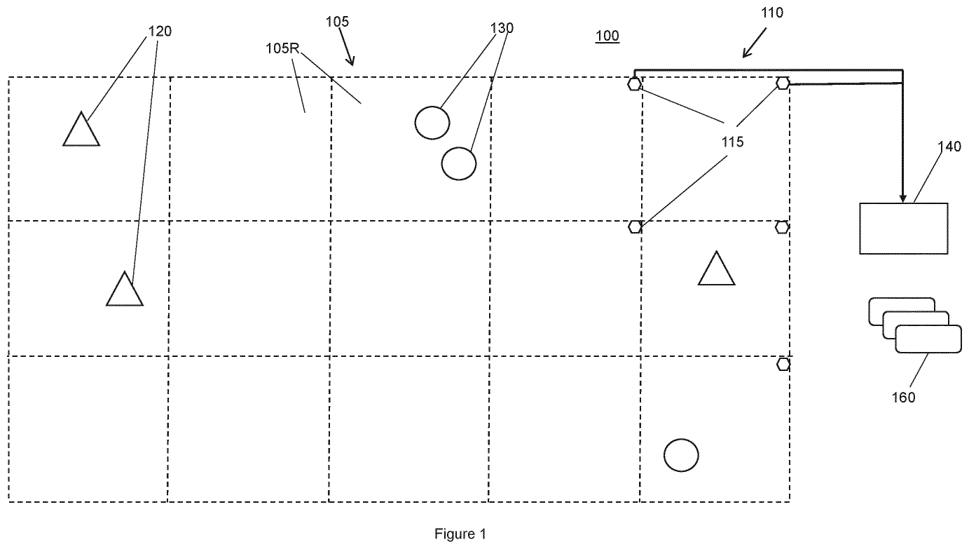

FIG. 1 illustrates a system according to an embodiment. The system 100 comprises a sensor grid 110, a task model 160 and a controller or apparatus 140 configured to perform a task associated with a working space 105 such as a smart warehouse floor. The sensor grid 110 comprises a plurality of sensors 115, only a small number being illustrated for simplicity. The working space 105 may be divided in a number of regions 105R, each region being associated with one or more sensors 115. In an embodiment the system may be configured for a particular task such as detecting persons 130 or other predetermined objects to assist with the control of automated devices 120 such as autonomic guided vehicles (AGV), for example to avoid collisions between humans 130 and the automated devices 120. However, the system 100 may be configured for different tasks such as quality assurance of automated devices, improving human interaction with machinery, security and intruder alert tasks, or the detection of potentially dangerous situations such as the build up of certain gases, and product line reconfiguration to reduce end-product imperfections.

The controller or apparatus 140 is arranged to receive data collected by the sensors 115 in the working space 105 and to apply this to a task model 160 in order to perform a desired task, such as detecting humans 130 within the working space 105. This information can then be passed to a controller which controls AGVs 120 to prevent collisions with the detected humans 130. The apparatus 140 may be configured to use the minimum energy necessary to perform the task at a wanted accuracy. The apparatus 140 may use a different model 160 and/or receive different data from the sensor grid 110 in order to perform different tasks. The apparatus 140 may additionally or alternatively be arranged to configure the system to perform the task using the lowest energy consumption. The configuration itself may be arranged to be performed using a minimum of energy consumption, for example by minimizing model training.

Various different types of sensors 115 may be used such as cameras, thermal imaging sensors, thermometers, chemical detectors, acoustic, moisture, electrical, positional, pressure, flow, force, optical, speed and many other types. Each or a number of the sensors 115 may be tunable to output different resolutions of data as different tasks may require less information about the working space whereas other tasks may require detailed information. For example, detecting humans 130 to avoid collisions with AGVs 120 may require high resolution imaging whereas for a security task low a resolution heat signature may be sufficient.

Various ways of changing the resolution of sensor output to the controller 140 may include tuning the following parameters of the sensors: pixel resolution; sampling frequency; quantization; bandwidth; filtering; the number of sensors and/or the sensors selected. For example, a low resolution setting may comprise only one sensor per region 105R of the working space, with each sensor have a low energy setting of low resolution and sampling time. The resolution of the sensors may correspond to the energy they consume. A predetermined hierarchy of sensor resolution may be based on energy consumption where different combinations of sensor parameters may be used to correspond with higher energy consumption and higher accuracy.

The sensors may be hardwired or wirelessly coupled to the controller, for example using a communications standard such as WiFi™ or Bluetooth™. The sensors may be Internet of Things (IoT) devices that communicate using a cellular communications standard such as LTE or 5G from the 3GPP. Data transmissions to the controller 140 may be made using cabling, wirelessly and/or over the Internet. In some embodiments the controller may be located in the cloud and arranged to perform the task and/or configure the system remotely from the sensor grid.

Higher resolution sensing will require higher energy consumption by the sensors and may also require more energy intensive data transmission to and/or data processing by the controller 140. Unnecessarily high energy consumption may be undesirable for a number of reasons including power supply cost associated with operating the system, failing to meet certain regulatory or environmental requirements, increased need to replace batteries in sensors that reply on this source of power.

In an embodiment, the controller 140 may also be arranged to configure the system 100 for new or different tasks. This may involve adjusting the resolution of the sensors 115 and/or the complexity of the task model 160 used to process the data collected about the working space 105.

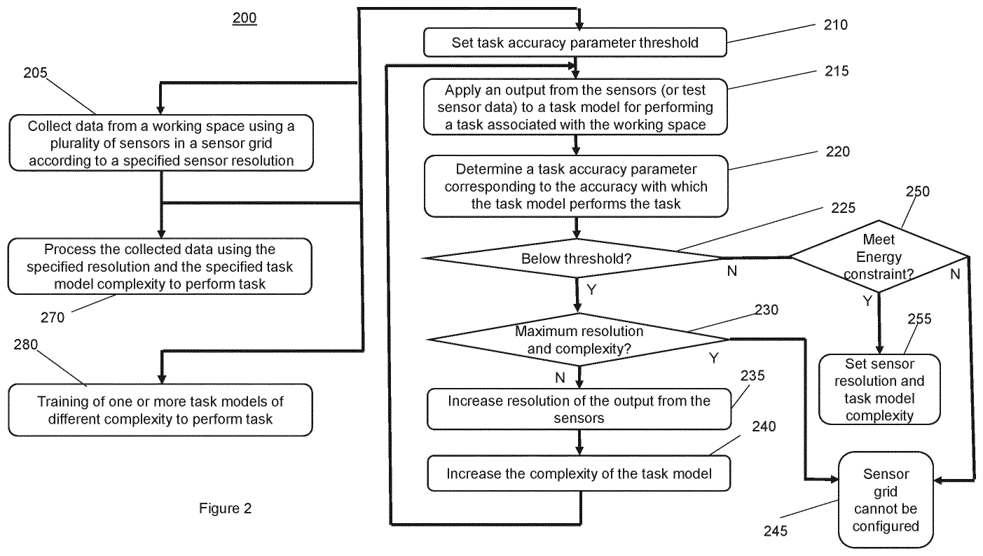

FIG. 2 illustrates a method of configuring a system such as the system of FIG. 1, although other arrangements may be similarly configured. This method 200 may be implemented by the system 100 with data collecting step 205 implemented by the sensors 115 and configuring, operating and/or training steps 210-280 implemented by the controller 140. However, in alternative embodiments configuring steps 210-255 may be implemented by a different controller or apparatus to the controller 140 that implements the operating step 270 and/or the training step 280.

At 205, the method collects data from a working space using a plurality of sensors in a sensor grid according to a specified sensor resolution. The sensor resolution may be defined in a number of ways, for example pixel resolution, sampling frequency, the number of sensors per working space region 105R and various other adjustable or tunable parameters. Depending on the sensors 115 and the wanted task, increasing the resolution of the sensors may comprise a predetermined combination of increasing some parameters either together or in a particular order. For example, starting at a lowest resolution setting, the resolution may first be increased by increasing the pixel resolution, then increasing the sampling frequency, then reducing the quantization, then increasing the pixel resolution again and so on. Various other resolution increasing algorithms could alternatively be used.

The data collected by the sensors at the specified sensor resolution may then be used to configure the system for a particular task. Once configured, the collected data may be used by the system to perform the task at 270. The collected data may also be used to train task models at 280 and as described in more detail below.

At 210 a task accuracy parameter threshold is set. This corresponds to a key performance indicator (KPI) for the task for which the system is being configured. The task may be AGV accident prevention and the KPI may be 99%. Domain experts may then use this requirement or system specification to determine a task accuracy parameter threshold corresponding to person or worker identification at 90% accuracy, which it may have been determined is sufficient for smart factory settings where workers are always in groups.

An energy use constraint may also be set, for example a given kWh value to operate the system once configured, and/or to configure the system and/or to train a number of task models. An example may be to set training at 60% of an available energy budget and to set operation of the trained and configured system at 30% of the available energy budget.

At 215, the method applies output form the sensors to a task model for performing a task associated with the working space, for example AGV accident prevention. In this embodiment the task model is pretrained though in other embodiments the task model may require full or partial training as described in more detail below. The output from the task model may be detection of a person at a particular region 105R, or another task dependent output.

At 220, the method determines a task accuracy parameter corresponding to the accuracy with which the task model performs the task. This may be determined by using a testing regime in which persons are assigned to particular regions 105G and the output of the task model correlated with these known positions. The method may alternatively be automated by applying predetermined sensor test data to the test model and assessing the output of the task model to determine accuracy.

At 225, the method determines whether the task accuracy parameter is below the task accuracy parameter threshold. The method typically starts with a lowest sensor resolution and a lowest complexity task model as these represent the lowest energy consumption configuration. However, such a configuration may not be accurate enough for some tasks in which case a higher sensor resolution and/or a higher complexity task model may be required. If the task accuracy parameter is below a threshold, for example the 90% accuracy mentioned above in relation to person detection, then the method moves to step 230.

At 230, the method determines whether the maximum sensor resolution and maximum task model complexity has been reached. If not, the method moves to step 235. If the maximum sensor resolution and task model complexity has been reached the method moves to step 245.

At 235, the resolution of the output from the sensors is increased. This may be increased by using additional sensors, increasing the pixel and/or sampling resolution of the current and/or additional sensors or any other mechanism for increasing amount of data collected by the sensor grid output, or the amount of sensor test data, applied to the task model. The higher resolution sensor data may be applied to the same task model, or a more complex model may be used.

At 240, the complexity of the task model is increased. Increasing the complexity of the task model may comprise using a task model with different architectural parameters including for example increasing the model's input resolution, layer depth and/or layer width as well as the types and order of different types of layers such as convolutional, pooling, etc. An increase in one or more of these parameters may be needed to accommodate higher resolution sensor data, although in some cases higher resolution data may be accommodated by the same task model. The embodiment may use pre-trained task models of varying complexity and simply switch to a high complexity model.

The method may increase one or both of the sensor resolution and the task model complexity and different algorithms for increasing these may be employed at each iteration. The method then returns to step 215 where sensor data collected by the sensor grid or provided as predetermined sensor test data is again applied to a task model. The sensor data may be at a higher resolution and/or the task model may have a higher complexity, depending on the implementation of steps 235 and 240 in the previous iteration. The method again determines the task accuracy parameter at 220 and checks this against the task accuracy parameter threshold at 225. If this threshold is still not reached, another iteration is performed of increasing the sensor resolution and/or the model complexity.

If the maximum sensor resolution and maximum task model complexity has already been reached, as determined at 230, the method moves to 245 to indicate that the sensor grid cannot be configured to provide the desired KPI. This could be addressed by training and using a higher complexity task model and/or increasing the resolution of the output of the sensor grid, for example by installing additional and/or more accurate sensors in to collect data associated with the working space. Alternatively, a lower KPI may be deemed acceptable, and the method run again with a correspondingly lower task accuracy parameter threshold.

If the task accuracy parameter reaches the set task accuracy parameter threshold, as determined at 225, the method moves to 250 to determine whether a predetermined energy constraint has been met. Alternatively, this step may be omitted where it is accepted that the lowest energy configuration will be used. Where the energy constraint is not met, the method moves to step 245. Where the energy constraint is met, or where no energy constraint is set, the method moves to step 255.

At 255, the method sets the sensor resolution and the task model complexity for operation by the system. This is known as the Inference mode where data is collected from the working space using the plurality of sensors according to the set sensor resolution at step 205. This data collected at the set sensor resolution is processed or applied to the task model of specified complexity at step 270. The task is therefore performed at the required accuracy in order to meet the set KPIs, such as 99% collision avoidance at or below a predetermined energy budget.

Where the task is object detection, the controller 140 may output person detection data to another controller which controls AGV's within the working space. This data may be used to stop AGV's about to collide with a person or to re-route them around the person. In a quality assurance task, the controller 140 may output a quality level of an element built in a factory (working space). This data may then be used to trigger a robot to pick up that element and move it to a different area for deeper analysis and/or root cause analysis. Many other tasks may be configured and the controller output used to trigger follow on control or analysis.

The task models of different complexity may be pre-trained neural networks. These neural networks may be trained at 280 using the collected data from the sensors or using test sensor data. Partially trained task models may be obtained from other similar working spaces so that transfer learning can be employed to reduce energy consumption. These partially trained models may then be fully trained using data collected from the new working space or test data corresponding to this. The task models may be scalable neural networks such as those provided by EfficientNet which provides families of convolutional and LTSM recurrent neural networks having different architectural parameters such as input resolution, layer depth and layer width. EfficientNet networks are available for example from the Keras open source library at https://keras.io/ Other scalable neural network architectures may alternatively be employed.

This advantageously allows a system employing the sensor grid and task model to be configured and operated at a minimum task accuracy whilst minimizing energy usage. This is achieved by finding the lowest resolution and lowest task complexity required to achieve the wanted task accuracy. By starting with a low sensor resolution and/or task model complexity, then increasing this to attain the predetermined task accuracy, an energy efficient configuration for the system is determined. This configuration may then be deployed to perform the desired task, whilst at the same time minimizing the energy requirements of the system. This approach also represents the lowest task model training overhead where task model training is required, further minimizing energy consumption in those situations.

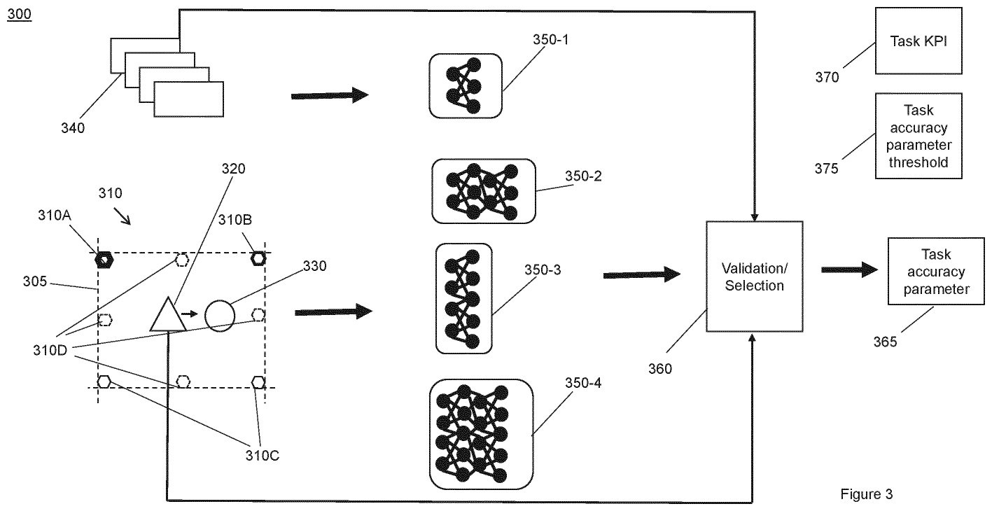

FIG. 3 illustrates training and selection of task models for a system using a sensor grid according to an embodiment. The training and/or task model selection system 300 comprises a number of task models 350-1-350-4 of increasing complexity. Some neural network architectural parameters of the models may be increased to increase complexity, including for example input resolution, layer width and layer depth. Increased layer depth may be required when increasing layer width although in some cases increased layer depth may be used for the same layer width in order to improve predictions. The system may also include a task model validation and/or selection module 360.

Inputs to the task models 350-1-350-4 may include one or both of sensor test data 340 and live collected data from a sensor grid 310 arranged to collect data from one or sensors associated with a working space 305. A first set of density of sensors 310A may comprise a limited number, a second set of sensors 310A, 310B may increase the number and/or density of sensors associated with the working space. Additional sensors 310C and/or 310D may be employed to increase the resolution of the sensor grid and collect more data about the working space. The output from the sensors may additionally or alternatively been made higher resolution (more collected data) by increasing resolution parameters associated with one or more individual sensors. Such resolution parameters may include pixel resolution, sample frequency, quantization and so on as previously noted.

In a training mode, each task model 350-1-350-4 may be individually trained by applying training data which is correlated with some known output condition so that the model may be trained using gradient descent or other training methods. The training data may also correspond with the complexity of the model being trained, such as providing more training data points for more complex models. For example, temperature data from multiple sensor locations may be associated with known locations of persons within the working space and the models may be trained to predict locations of persons from input sensor data. The training data may be in the form of predetermined sensor sample data 340 or live sensor data collected by sensors 310A-D in the sensor grid.

After a training period, test data may be applied to the task model to test its accuracy, for example at detecting persons. Further training periods may be performed to improve accuracy. A validation engine 360 may be employed to control training, for example to stop training when no further improvements to accuracy are being made.

Training of a particular model 350-1-350-4 may start with low sensor resolution training and test data to determine a maximum task accuracy parameter for that setting. If this is below a task accuracy parameter threshold 375, a higher sensor resolution may be used and the model further and tested. The task accuracy parameter threshold 375 may be set by domain experts based on task KPI 370 provided to them by operators of the working space. Higher and higher sensor resolution settings may be used until either the trained model reaches the task accuracy parameter threshold or the model is no longer capable of accommodating higher resolution sensor the data.

At this point, training of a new more complex task model, for example 350-2, begins. The resolution of the sensor data may be the same as that last provided to the previous less complex model 350-1, or training may start with lower resolution sensor data. The same training process then occurs with the new task model 350-2, with training and testing until either the task accuracy parameter threshold is met of no further gains in task accuracy parameter are being made with further training. The resolution of the sensor data is then increased and further training of the new model 350-2 commenced. Again, if it is not possible to reach the task accuracy parameter threshold at the maximum sensor resolution that the model can accommodate, a new more complex model 350-3 may then be trained. This process continues until a sensor resolution and model complexity is found that provides a task accuracy parameter 365 that meets the task accuracy parameter threshold 375.

This process results in a minimum task model complexity and lowest sensor resolution required to meet the Task KPI. This naturally also ensures that the minimum energy is consumed by the model and sensor grid when performing the task. In addition the minimum energy is consumed in training the task models and more complex models that are not required are not trained.

The task models may also utilize some level of transfer learning in order to reduce training processing. For example, the pre-trained models may be commercially available image classifiers, for example from EfficientNet. These neural networks are already partly trained to recognize objects, with preconfigured architectures and node weights. Having partially trained models significantly reduces the training time required using the working space sensor data. In other examples, task models already trained for similar tasks on the working space may be used, with further training being undertaken for the new task. In another example, task models already trained for the same task but on a different working space by be used, with further training being undertaken using data associated with the new working space. Trained models may then be stored and used as pre-trained models for different tasks and/or different working spaces.

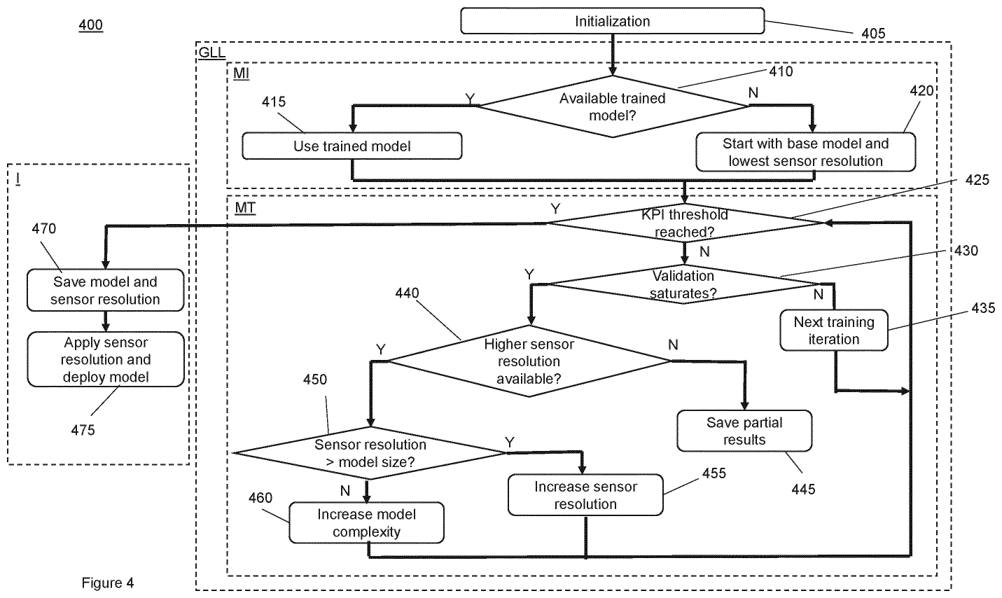

FIG. 4 illustrates a method of configuring a system such as the system of FIG. 1, although other arrangements may be similarly configured. This method 400 incorporates training of task models as part of the configuration. In this embodiment, the method is described in the context of configuring a factory sensor grid system used to monitor worker movement to be able to send notification messages to approaching autonomic guided vehicles (AGVs), although the factory sensor grid system or other sensor grid systems may be configured for different tasks using the method.

In this embodiment a thermal array system is used that monitors the temperature of the shopfloor with a certain spatial resolution. To configure the system for the task, the system starts training from a smallest sized EfficientNet BO convolution neural network and a low thermal array resolution. The system iterates through the training process, increases the sensor grid resolution to be able to detect the humans by their temperature and to be able to distinguish from other heat dissipating devices. Once the use-case level validation accuracy has reached the necessary safe human detection level the system stops the training. This may occur even when the applied neural network accuracy is not saturated, since the that specific network could detect much finer grained details. But this is not required for the specific task and instead the lowest energy configuration to accomplish the task is determined. This way the system uses the least amount of input data combined with the smallest neural network possible.

At 405, initialization is performed in which the task or use case is defined. In the present example use case, the target is the detection of people's motion in a smart factory setup based on their temperature signatures while using minimal overall energy. For minimization of training cost, we use minimal data and minimal neural network size. Hence, with lowest B0 model and lowest sensor resolution is used when starting the training. The use case KPI target is the prevention of accidents in the factory, and detection of dangerous situations with high enough accuracy. This doesn't translate directly to the same threshold in human detection per temperature data snapshot, as a series of snapshots can be used for human motion detection for a decision/alert made in time. In the example situation, if the use case KPI is not met, the sensor resolution is increased until model increase is also performed. This iteration is driven until a wanted or set accuracy is reached. This is the most energy efficient setting of the system. If the wanted accuracy cannot be met, this indicates that the use case KPI, sensor grid design, maximum model parameters or accuracy threshold needs to be changed.

The method is able to reduce energy consumption during the model training, by carefully increasing model features only if needed, by carefully increasing model complexity only if needed, by carefully increasing sensor resolution only if needed, and, during the model inference due to the selection of the less complex ML model that fulfils the use case KPI.

In the embodiment the following initialization is used. Use case KPI: successful alert rate for avoidance of collision between AGV and workers to reach minimum 99% accuracy, so that AGV can continue without blocking emergency stop function activation. Energy/accuracy priorities: the factory has an available energy budget of X kJ for this use case, and an example would be to set the training energy cost to 60% of available budget if we know that other use cases are of higher training demand. This tradeoff can be the result of an iterative optimization process between use case costs competing for total budget. There is a pre-set priority list based on intent from domain expert and business management input of the concurrent constraints.

A KPI threshold or task accuracy parameter threshold may be determined by a domain expert or from a lookup resource to meet the required use case KPI, in this example 99% collision avoidance between AGVs and human workers. In order to achieve this a KPI threshold or worker detection accuracy of, for example, 91% may be sufficient.

Following initialization, task model initialization steps (MI) 410-420 are performed. At 410, the method determines whether a trained task model is available for a particular level of complexity. The method starts with a low complexity model for training and only if needed increases the complexity. If a trained model is available, 415, this is used for the training. The model may be fully trained, for example because this currently assigned task has already been utilized for the factory floor but fine tuning is required because of a slight change in factory floor layout or the installation of new equipment. Similarly, a trained model may be available from a similar factory floor or from a similar task, for example one which requires detection of humans at a higher or lower accuracy. If a trained model is not available, a base model is used, 420, for example from a commercially available image classifier scalable neural network provider. In this case the lowest available sensor resolution is used as a starting setting. In the case of a trained model, a higher resolution setting may have been used to complete training and in that case this higher sensor resolution is used. In either case, the lowest available sensor resolution is used to start the process in order to ensure the configuration process and the configured system use the lowest energy possible. Examples of different model complexity and sensor resolution have been described previously.

The method then enters a greedy training loop or model training section (MT) in which the current model is trained and tested for meeting the KPI threshold. If this does not occur, the sensor resolution is increased, and further training and testing performed. More complex or higher resolution models are also employed if the KPI threshold is still not meet, and these are trained and tested until either a combination of model complexity and sensor resolution is found which meets the KPI threshold, or the KPI threshold cannot be meet by available sensor resolution and model complexity settings.

At 425, the method determines whether the KPI threshold or task accuracy parameter threshold has been met by the current model and sensor resolution setting. This may be implemented in various ways as previously described, for example using test data applied to the (partially) trained task model. If the KPI threshold has been met, the method moves to 470 where the trained task model and sensor resolution are saved. This is the inference (I) section of the method 400, and the method then moves to 475 for applying sensor output at the saved sensor resolution to the trained task model in order to perform the task. In this example collision avoidance between AGVs and human workers.

If the KPI or task accuracy parameter threshold has not been met the method enters an inner loop that trains the task model using sensor data with unchanged neural network resolution or complexity and unchanged sensor grid resolution. At 430, the method determines whether the model training has saturated, that the training iteration gain stops improving. For example, it may be determined that the task accuracy parameter remains a present threshold below the required task accuracy parameter threshold. If this is not the case, the method moves to the next training iteration at 435. As previously described, this may involve applying sensor training or sample data to the model, with feedback such as gradient descent used to further tune the model parameters. The method then returns to 425 to check whether the further trained model can now reach the KPI threshold. The model may be checked every N training iteration steps. This loop continues until the model training saturates or the trained model meets the KPI threshold.

If the training saturates, the method enters a second loop by determining whether a higher sensor resolution is available at 440. If a higher resolution is not available, then it will not be possible to achieve the required KPI threshold and the method moves to 445 where the partial results may be saved. This may be used for future configuration for example if higher sensor resolution becomes available by adding more sensors to the grid, then the partially trained model may be used at the starting point (415) for a subsequent configuration method.

If higher sensor resolution is available, the method moves to 450 to determine whether the current task model is able to accommodate this; in other words whether the sensor resolution is greater than the model resolution or size. If the current model complexity, resolution or size is sufficient, then the method proceeds to 455 where the sensor resolution is increased as previous described. The method then returns to the training loop where the task model is further trained (435) using the higher resolution sensor data and is tested for meeting the KPI threshold (425), saturation (430) and if need be whether yet higher sensor resolution is available (440).

If the current task model cannot accommodate the higher sensor resolution, the method moves to 460 where a more complex model is used for further training and testing. The more complex task model may be a larger size, have a greater layer depth and/or width or have other architectural parameters that are greater than the previously used model. This higher complexity or resolution task model is able to accommodate more input data from the sensor grid, for example data from more sensors, higher pixel resolution from each sensor or a higher sampling rate as well as other sensor resolution parameters as previously described.

The method 400 continues until either the KPI threshold is reached (470) or higher sensor resolution is no longer available (445). This method allows the smallest model with the lowest sensor resolution to be found that meets the use case KPI whilst using the least amount of training. This ensures minimum energy is used in training and that the lowest energy configuration model complexity and sensor resolution is used in performance of the task.

The described methods may be implemented in the system of FIG. 1 by executing instructions 155 stored in the memory 160 and using the processor 140 of the apparatus or controller 140, although alternative implementations may be used.

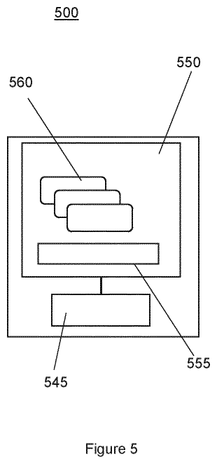

FIG. 5 illustrates an apparatus or controller 500 arranged to configure a sensor grid system. The sensor grid system may be the system of FIG. 1 which comprises a plurality of sensors 115 distributed to collect data from a working space 105. Alternatively, any other sensor grid system may be configured by the apparatus 500.

The apparatus 500 comprises a processor 545 coupled to memory 550 containing instructions 555 executable by the processor 540 to configure a sensor grid system, for example using the methods of FIG. 2 or 4. The apparatus 500 may also be used to operate the sensor grid system once configured. The apparatus 500 may also comprise one or more task models 560 of different complexity in order to perform a task at different levels of accuracy. The apparatus may also comprise task models configured for different tasks that may be reconfigured for a new task or used to operate the sensor grid system to perform different tasks.

In an embodiment, the apparatus 500 receives data collected by sensors of a sensor grid system associated with a working space 105 and applies this to a task model 560 in order to perform a desired task, such as detecting humans 130 within the working space 105. In another embodiment, the apparatus 500 receives data collected by sensors of a sensor grid system associated with a working space 105 to configure the sensor grid system to perform a predetermined task with a predetermined accuracy. This configuration may include selecting a sensor resolution and task model complexity capable of performing the task with the required accuracy whilst minimizing energy consumption. This configuration may include training the (or a number of) task model.

Embodiments may provide a number of advantages. For example, minimal energy cost for training can be used to find the lowest-energy inference settings. Model transfer learning may be employed to further reduce energy consumption. The configuration methods may be applied for multiple tasks using the same sensor grid hardware in a given working space. Efficient use may be made of commercially available scalable neural network models for different tasks and/or accuracy requirements. Trained models may be used for other tasks or for different working spaces to further reduce overall energy consumption. Model scaling can be adapted for time series analysis by changing Multi-modal sensor grid resolution to sensor time series resolution, or EfficientNet CNN family to EfficientNet as LSTM feed.

Whilst the embodiments have described with respect to a particular AGV collision avoidance task, many other applications are possible, including for example working space security, equipment quality assurance using vibration and electromagnetic sensors, robot human interaction control and many other tasks.

Some or all of the described apparatus or controller functionality may be instantiated in cloud environments such as Docker, Kubenetes or Spark. This cloud functionality may be instantiated in the network edge, apparatus edge, in the factory premises or on a remote server coupled via a network such as 4G or 5G. Alternatively, this functionality may be implemented in dedicated hardware.

Modifications and other variants of the described embodiment(s) will come to mind to one skilled in the art having the benefit of the teachings presented in the foregoing descriptions and the associated drawings. Therefore, it is understood that the embodiment(s) is/are not limited to the specific examples disclosed and that modifications and other variants are intended to be included within the scope of this disclosure. Although specific terms may be employed herein, they are used in a generic and descriptive sense only and not for purposes of limitation.

1. A method of configuring a sensor grid system having a plurality of sensors arranged to collect data from a working space, the method comprising:
applying an output from the sensors to a task model for performing a task associated with the working space;
determining a task accuracy parameter corresponding to the accuracy with which the task model performs the task; and
in response to the task accuracy parameter being below a task accuracy parameter threshold:
increasing the resolution of the output from the sensors; and
increasing the complexity of the task model.

2.-14. (canceled)

15. The method of claim 1, comprising using the resolution of the sensors and the complexity of the task model to perform the task using the data collected from the plurality of sensors.

16. An apparatus for configuring a sensor grid system having a plurality of sensors arranged to collect data from a working space, the apparatus comprising a processor and memory containing instructions executable by the processor to configure the apparatus to:
apply an output from the sensors to a task model for performing a task associated with the working space;
determine a task accuracy parameter corresponding to the accuracy with which the task model performs the task; and
in response to the task accuracy parameter being below a task accuracy parameter threshold:
increase the resolution of the output from the sensors; and
increase the complexity of the task model.

17. The apparatus of claim 16, wherein the task comprises:
detecting predetermined objects; controlling automated devices; quality assurance of automated devices; identifying security threats.

18. The apparatus of claim 16, operative to increase the resolution of the output from the sensors again, following increasing the complexity of the task model.

19. The apparatus of claim 16, wherein the sensors are arranged to monitor respective regions of the working space and the task comprises detecting predetermined objects.

20. The apparatus of claim 19, wherein the predetermined objects are persons and an output of the sensor grid is used to control automated devices within the working space.

21. The apparatus of claim 16, wherein the resolution of the output from the sensors is increased by tuning any one or more of the following parameters of the sensors: pixel resolution; sampling frequency; quantization; bandwidth; filtering; the number of sensors.

22. The apparatus of claim 16, wherein the task model is a pre-trained neural network.

23. The apparatus of claim 22, comprising a training module configured to generate the trained neural network by one or more of: training an untrained neural network using the output from the sensors; using transfer learning from another trained neural network trained using a different working space.

24. The apparatus of claim 22, wherein the memory contains a plurality of neural networks of different complexity.

25. The apparatus of claim 22, wherein increasing the complexity of the task model comprises using another neural network having an increase in one or more of the following architectural parameters: input resolution; layer depth; layer width.

26. The apparatus of claim 20, wherein the task model is a neural network trained using the output from the sensors together with person sensing data from the automated devices.

27. The apparatus of claim 20, wherein the task accuracy parameter threshold corresponds to a collision avoidance limit between persons and automated devices and a requirement to minimize energy use by the sensors and task model.

28. The apparatus of claim 27, comprising adding more sensors to the sensor grid in response to the task accuracy parameter threshold not being reached.

29. (canceled)

30. The apparatus of claim 29, wherein the memory comprises the task model.

31. A system comprising a sensor grid having a plurality of sensors arranged to collect data from a working space and a task model, the sensors and the task model configured by an apparatus, the apparatus comprising a processor and memory containing instructions executable by the processor to configure the apparatus to:
apply an output from the sensors to a task model for performing a task associated with the working space;
determine a task accuracy parameter corresponding to the accuracy with which the task model performs the task; and
in response to the task accuracy parameter being below a task accuracy parameter threshold:
increase the resolution of the output from the sensors; and
increase the complexity of the task model.

32. The system of claim 31, wherein the apparatus is further configured to configure the sensor grid.

33. The system of claim 31, wherein the sensors comprise one or more of the following: thermometers; thermal imaging sensors; cameras.

34. (canceled)

35. A non-transitory computer readable storage media having stored thereon a computer program that, when executed, performs a method of configuring a sensor grid system having a plurality of sensors arranged to collect data from a working space, the method comprising:
applying an output from the sensors to a task model for performing a task associated with the working space;
determining a task accuracy parameter corresponding to the accuracy with which the task model performs the task;
in response to the task accuracy parameter being below a task accuracy parameter threshold:
increasing the resolution of the output from the sensors; and
increasing the complexity of the task model.
